(19) United States
(12) Patent Application Publication
(10) Pub. No.: US 2007/0007048 A1
(43) Pub. Date: Jan. 11, 2007

(54) Luggage scale

(76) Inventor: Michael Gill, Prince George (CA)

Correspondence Address: ANTONY C. EDWARDS, SUITE 200 - 270 HIGHWAY 33 WEST, KELOWNA, BC, V1X 1X7, CA

(21) Appl. No.: 11/480,366

(22) Filed: Jul. 5, 2006

Related U.S. Application Data
(60) Provisional application No. 60/595,440, filed on Jul. 5, 2005.

(51) Int. Cl. G01G 19/56

(52) U.S. Cl. 177/131

(57) ABSTRACT

A luggage weight measuring device for integration into a luggage case, or between the luggage case and handle or for mounting to the luggage case handle. In one embodiment at least one electronic load measuring sensor is mounted directly between the handle and the luggage case, for example to a deformable member which deforms as the handle is lifted to take up the load carried by the luggage case. Deformation is mathematically related to the load. A processor determines the load corresponding to the deformation as detected by the sensors and displays the load on a user viewable display on the luggage case or handle.

### CROSS REFERENCE TO RELATED APPLICATION

This application claims priority from U.S. Provisional Patent Application No. 60/595,440 filed Jul. 5, 2005 entitled Luggage Scale.

### FIELD OF THE INVENTION

This invention relates to luggage weight measuring devices that are either integrated into the luggage, the luggage handle or attached to the luggage handle. The present invention incorporates electronic load measuring sensors directly between the handle and the luggage that the handle is attached to.

### BACKGROUND OF THE INVENTION

It is known that mechanical means exist to measure luggage weight by integrating typically spring loaded mechanisms into the luggage handle, or the luggage itself at the point of connection with the handle. These for the most part are physically complicated and therefore relatively expensive for the application.

Applicant is aware of patents regarding such as U.S. Pat. No. 2,518,973 issued to Atherton on Aug. 15, 1950 titled “Weighing Device for Suitcases”, which integrates a swing out spring loaded scale into the handle or body of a suitcase so that the weight of the suitcase may be determined.

U.S. Pat. No. 2,710,083 issued to White on Jun. 7, 1955 titled “Weighting Device for Luggage”, describes a scale built into an inverted U-Shaped handle containing bands that attach to the suitcase and a spring loaded scale pointer. The addition of a lock down button permits the limiting of relative movement between the handle and the case.

U.S. Pat. No. 2,759,577 issued to White on Aug. 21, 1956 titled “Weighing Device for Baggage”, describes an improvement to U.S. Pat. No. 2,710,083 wherein the load of the suitcase is carried directly by a spring. Flexible bands drive a scale pointer. Again a lock down is implemented to minimize relative movement between the suitcase and the handle.

U.S. Pat. No. 2,937,016 issued to Westman on May 17, 1960 titled “Handle Weighing Mechanism for Luggage”, describes a scale that is integrated into the suitcase. The handle is attached to spring loaded pins that in turn attach to a cross beam and drive a rack that acts on a pinion scale.

### SUMMARY OF THE INVENTION

The present invention serves to measure the weight of a piece of luggage by digital and sensor means using piezoelectric, strain gauge, or optical means such as backscatter, refractive index, or through beam transmission changes. The present invention may be integrated directly into luggage or applied as an add-on to existing luggage by attaching to the bottom side of the handle with the active surfaces engaging the handle and the hand lifting the luggage.

In summary, the present invention may be characterized in one aspect as a luggage scale which may be retrofitted to carrying cases such as luggage, and in a further aspect as the carrying cases themselves which incorporate the luggage scale. In the former, the luggage scale may be summarized as including a handle mountable to the carrying case, where the handle has a cross member and two down legs extending downwardly at opposite ends of the cross member. In the latter, the luggage scale as hereinafter described is mounted to the frame of the carrying case.

The cross member, whether alone or in conjunction with other structural elements, cooperates with at least one deformable member so that, when the handle is mounted to the carrying case, lifting of the carrying case by the handle deforms at least one of the deformable members or, if singular, deforms the sole deformable member, so as to elastically deform the deformable member(s) by a quantifiable deformation quantum related by a mathematical relationship to the weight of the carrying case. A sensor senses the deformation of the deformable member(s).

The sensor includes collectively a sensing element or a plurality of sensing elements and their corresponding deformable members. In particular, the sensing element is mounted on the deformable member(s) for sensing the deformation quantum. The sensing element may be a strain gauge, which, for example, may include piezo film sheet. A processor cooperates with the sensor. The sensor relays the quantum data corresponding to the deformation quantum to the processor. The processor determines the weight of the carrying case according to the mathematical relationship.

A display cooperates with the processor for displaying the weight of the carrying case as determined by the processor.

In one embodiment of the present invention the cross member is rigid and the deformable member is at least one flexible member mounted between the cross member and corresponding the down legs. For example, where the opposite ends of the cross member are first and second ends, and where the flexible members include first and second flexible members, the first flexible member may be mounted to, so as to extend between, the first end of the cross member and a corresponding first down leg, and the second flexible member may be mounted to, so as to extend between, the second end of the cross member and a corresponding second down leg. In particular, the flexible members may be flexible plates.

Advantageously the cross member is elongate and the first and second flexible members are also elongate, and oppositely disposed, so as to extend from the ends of, and substantially parallel to, the cross member. In that embodiment the processor may be mounted to the cross member, as may be the display.

### BRIEF DESCRIPTION OF THE DRAWINGS

FIG. 1 is, in side perspective partial cutaway view, of the preferred embodiment of the present invention showing the handle, load cells, mounting plates, and electronics of the luggage scale.

FIG. 2 is, in side perspective view, of the luggage scale attached to a suitcase.

FIG. 3 is, in side perspective hidden line view, a second embodiment of the luggage scale in which the luggage scale base plate is the luggage frame.

FIG. 4 is, in side perspective hidden line view, the second embodiment of the luggage scale in which the luggage scale base plate is the luggage frame.

FIG. 5 is, in side perspective view, a third embodiment of the luggage scale in which the sensors, display, electronics, and battery are all contained within the luggage handle.

FIG. 6 is, in side perspective hidden live view, the third embodiment of the luggage scale with all components integrated with the luggage handle attached to a suitcase.

FIG. 7 is, in side view, a forth embodiment of the present invention in which the scale is integrated into the luggage and compressed by a retractable handle shown in a floating state.

FIG. 8 is, in side view, the forth embodiment of the present invention in which the scale is integrated into the luggage and compressed by a retractable handle shown in the operating, compressed, or lifting state.

FIG. 9 is, in perspective view, a further embodiment of the luggage scale according to the present invention.

FIG. 10 is, in front elevation view, the scale of FIG. 9 with the housing diagrammatically shown in dotted outline for clarity and wherein the wiring harness between the load sensors and circuit board are removed for clarity.

FIG. 11 is, in front elevation view, an alternative embodiment of the luggage scale according to the present invention.

FIG. 12 is, in rear elevation view, the luggage scale of FIG. 11.

FIG. 13 is, in bottom view, the luggage scale of FIG. 11.

FIG. 14 is, in plan view, the luggage scale of FIG. 11.

FIG. 15 is, in right side elevation view, the luggage scale of FIG. 11.

FIG. 16 is, in left side elevation view, the luggage scale of FIG. 11.

FIG. 17 is, in front perspective view, the luggage scale of FIG. 11.

FIG. 18 is an electrical schematic diagram of one embodiment of the luggage scale according to the present invention.

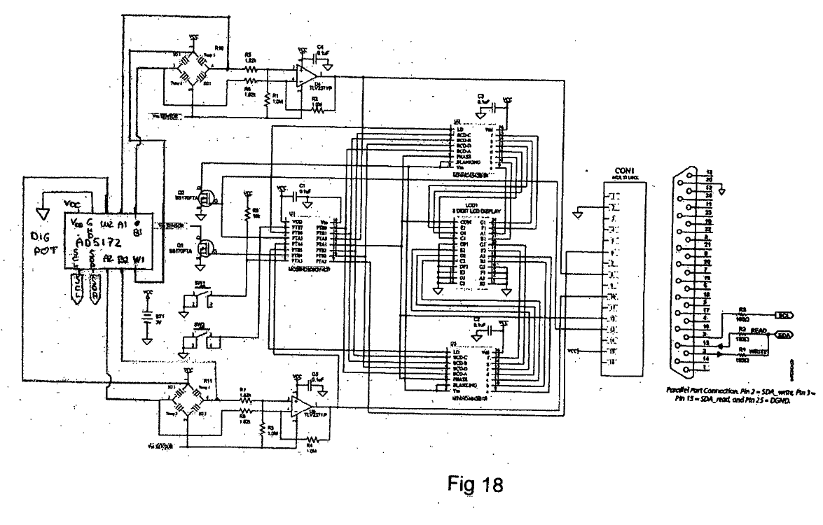

FIG. 19 is, in front view, a bridge plate during deformation (illustrated exaggerated for clarity) in an alternative embodiment of the luggage scale according to the present invention.

FIG. 20 is a schematic representation of a Wheatstone bridge used in the embodiment of FIG. 19.

### DETAILED DESCRIPTION OF EMBODIMENTS OF THE INVENTION

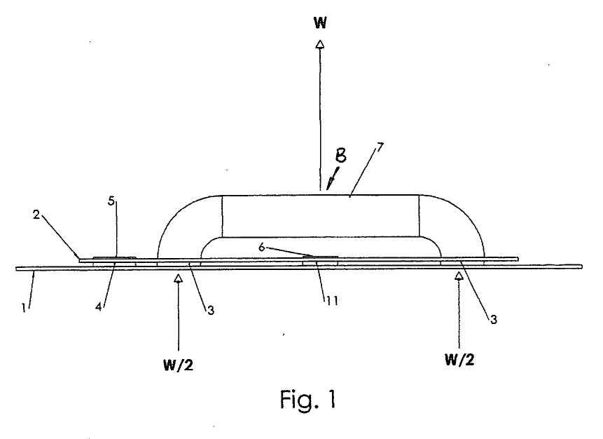

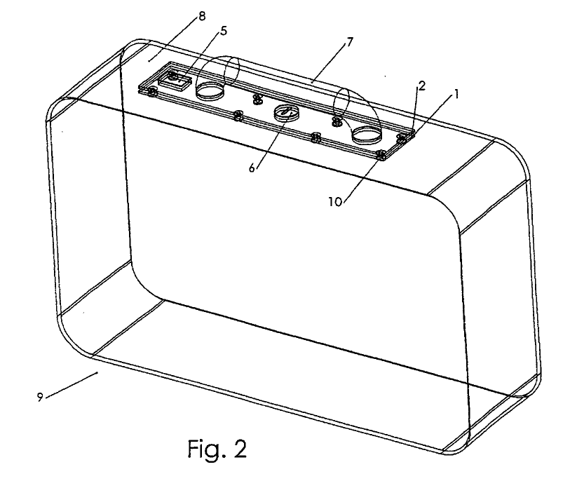

The present invention is a weight scale that is retrofit or integrated into existing suitcase designs. FIG. 1 shows the luggage handle 7, attached to load measuring sensors 3, which in turn are attached to plate 1. Plate 1 attaches to the top surface of a suitcase as shown in FIG. 2. Alternatively plate 1 may form part of the suitcase frame. The weight scale housing 2 is shown in FIG. 1 without sidewalls for clarity. The housing 2 houses the load measuring sensors 3, battery 6, electronics 4, and display 5. Assuming the suitcase has a weight W, when the suitcase is lifted by handle 7 at its balance point B, one half of the weight of the suitcase (W/2) is transferred through each load measuring sensor 3.

The load measuring sensor 3 may be a piezoelectric cell, which converts stress applied to the handle to a voltage, a linear variable differential transformer such as supplied by RDP Electronics Ltd. of Wolverhampton, West Midlands, United Kingdom, (rdpelectronics.com) and spring, or a variety of strain gauges such as supplied by Exact Sensor Technology (exactchina.com) of Senzhen, China. Given the short duration needed to weigh the suitcase, the structural strength under tension, and the requirement of low cost and compactness, the preferred embodiments of the luggage scale according to the present invention use strain gauges or piezoelectric sensors. Measurement Specialties, Inc. of Hampton, Va., USA, supply metallized piezo electric fluoropolymer film sheet under the trademark Piezo Film that can be attached to the handle and base plate or suitcase frame using a structural epoxy such as but not limited to, 3M's DP5060™. The Piezo Film produces voltage in proportion to compressive or tensile mechanical stress or strain.

The prior art outlined in the background above uses springs to bias a gauge. The gauge shows an approximation of the weight of the load, apparently based on a best-case linear spring constant, at least in respect of the teaching of Westman. The use of strain gauges or piezo film sheet or the like according to one aspect of the present invention is an improvement over the prior art. For example it provides increased accuracy. It also relies on very small quantifiable deformation, for example, small incremental strain, to obtain sufficient deformation quantum data so that a digital processor in the scale electronics may compute the load according to stress/strain equations well known to those skilled in the art. The use of small deformations by the load sensor(s) provides a solid feel to the user lifting the handle. That is, the handle does not appear to the user to resiliently give as would be the case where, as in the prior art, spring compression is relied on. Consequently, the present invention may be characterized by the structure unique to the load sensor's advantageous use of the contemplated stress/strain gauges, that is, as having a sensing element mounted on a deformable member.

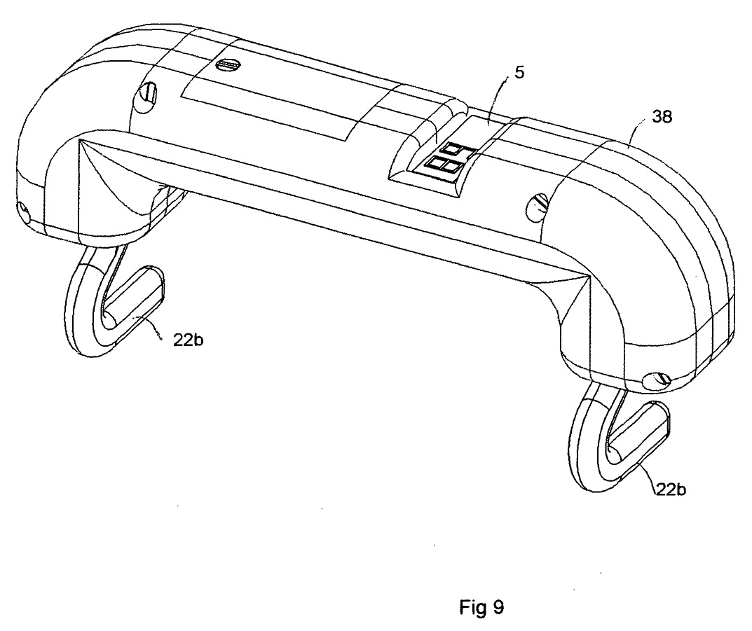

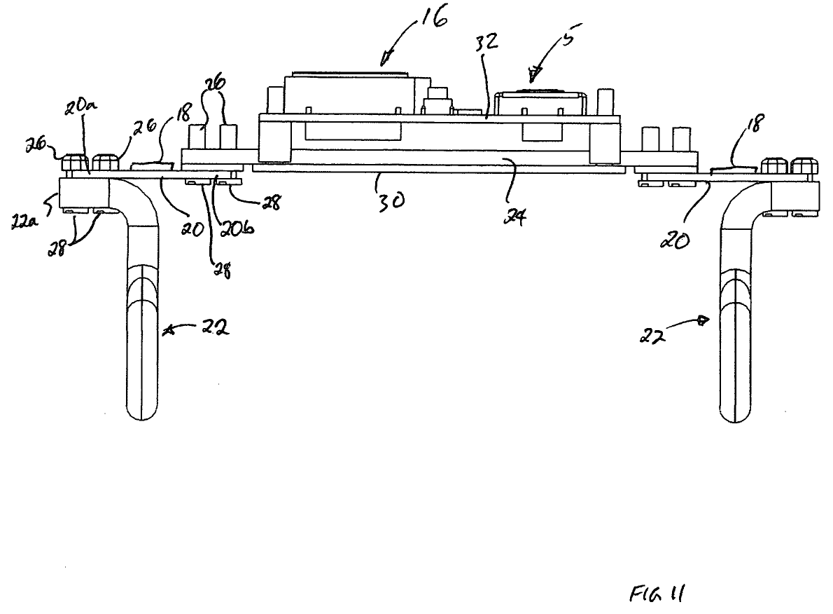

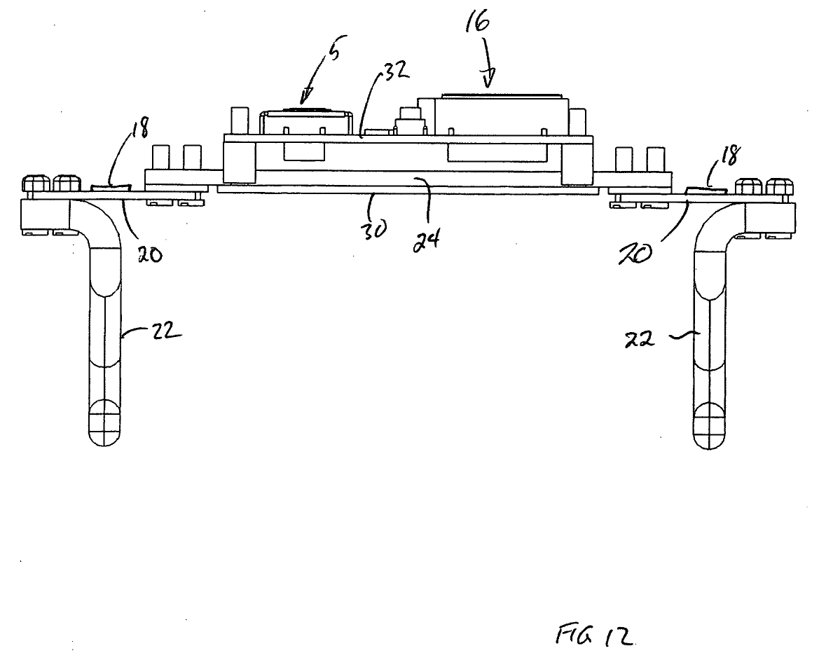

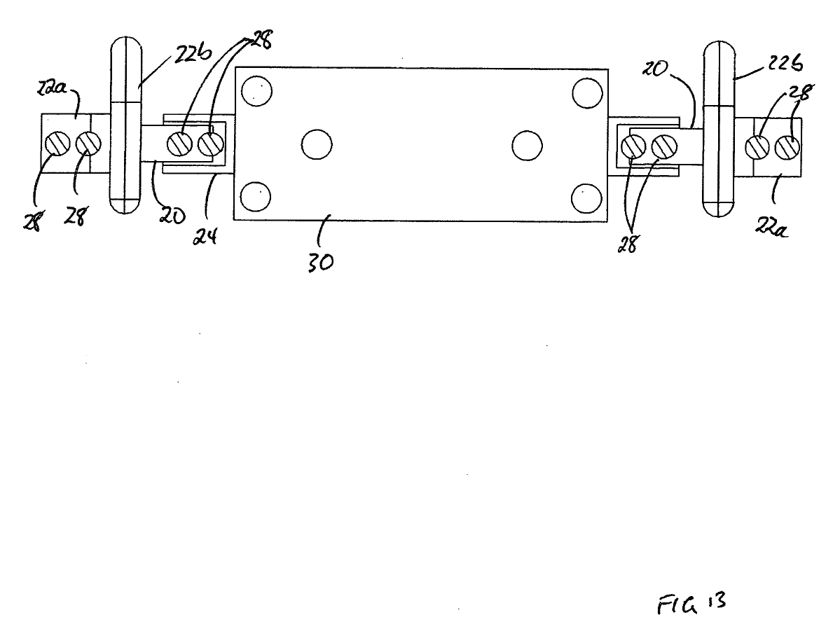

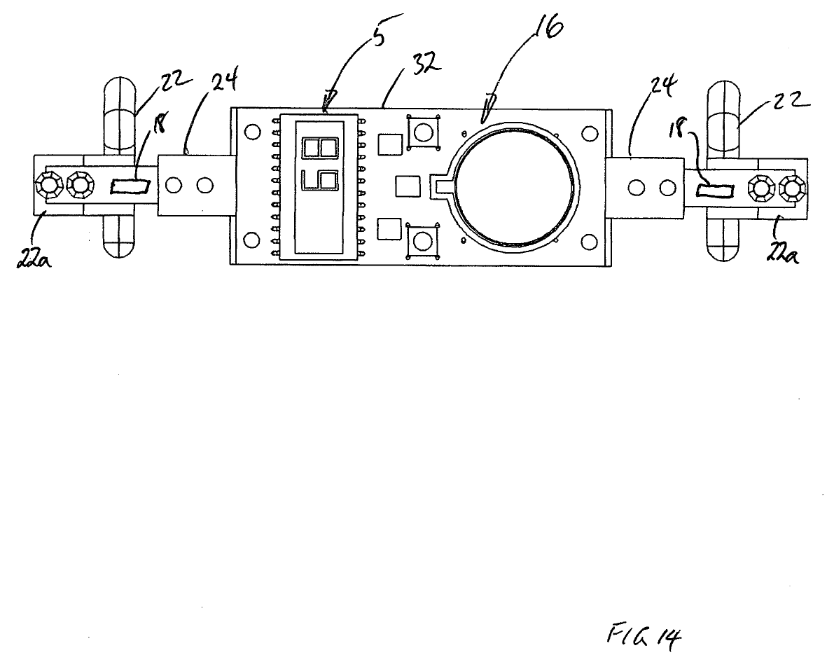

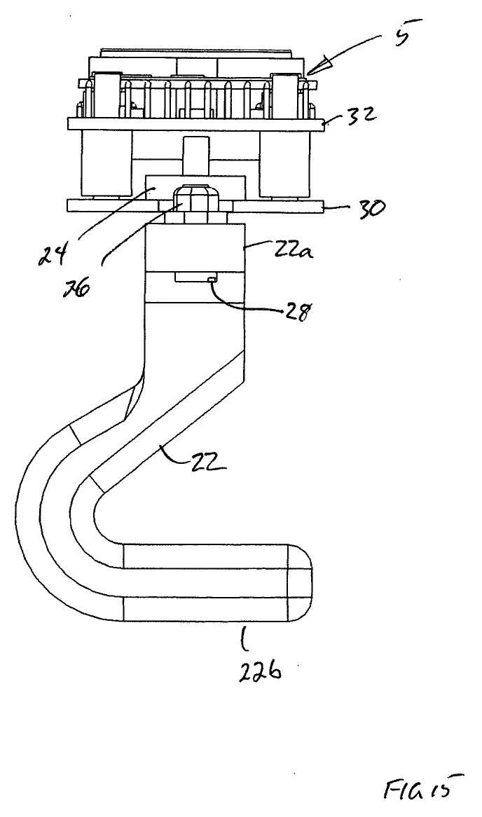

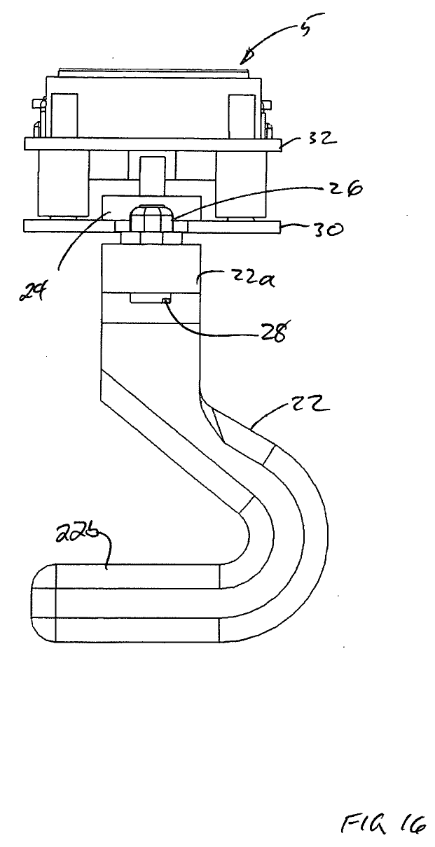

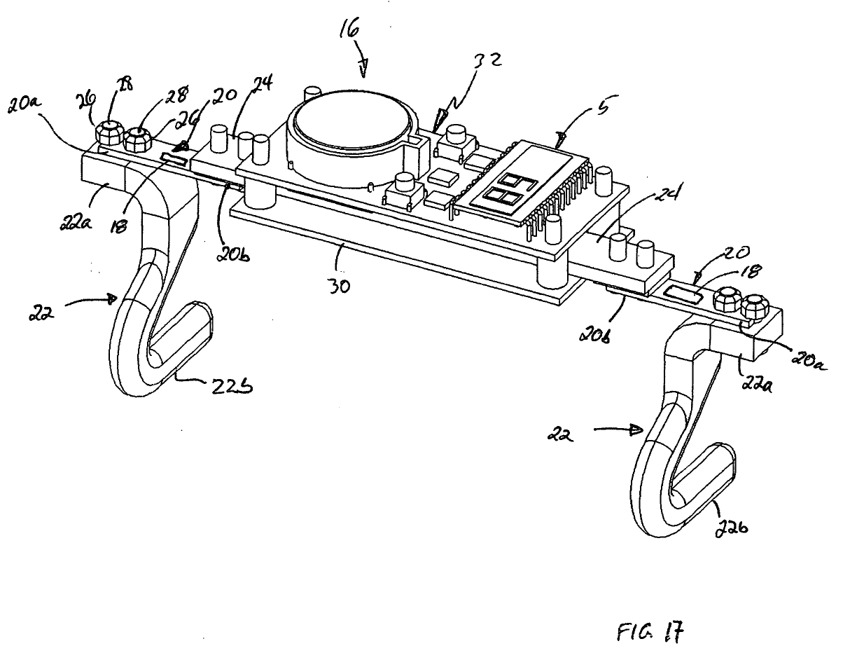

In the case of the use of conventional strain gauges, as described better below in respect of the embodiment of FIGS. 9-17, wherein a strain gauge 18 is mounted on a flexible plate 20, the strain gauge 18 per se is the sensing element and the flexible plate 20 is the deformable member.

One embodiment of the electronics 4 includes sensor conditioning, and an embedded controller which digitizes the sensor signals, applies gain and offsets, adds the resulting weights from one or more sensors (typically two) and displays the resulting weight. The controller will typically go into sleep mode to conserve battery power when the suitcase is not being lifted by the handle.

When the suitcase has not been lifted for some period of time the display remains blank until the handle is grasped and the suitcase lifted by the handle. The controller, after periodically polling the load sensors, wakes up, makes its calculations and displays the results, and continues to do so while the luggage is being held up by the handle and for some period after it has been released. Successive sampling of the sensors may use boxcar average, median, or some other filtering techniques to reduce noise.

Load sensor conditioning may use alternating current techniques to compensate for piezoelectric drift. Additional conditioning for temperature may also be required depending on the sensor characteristics.

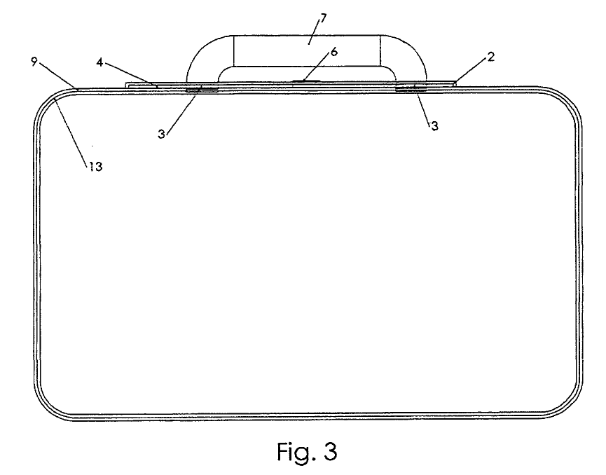

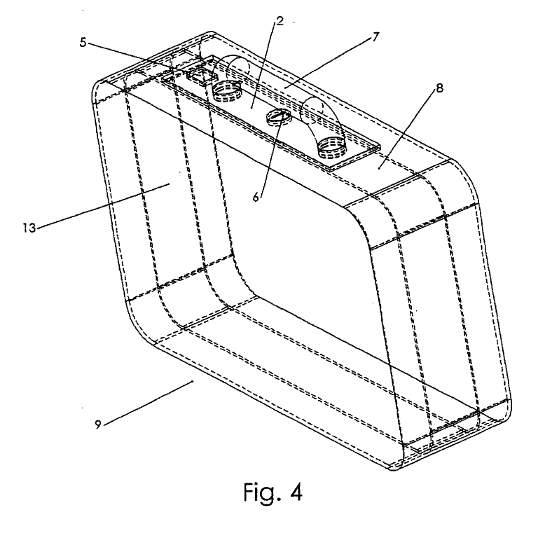

A second embodiment of the present invention uses the internal suitcase frame as the base plate as shown in FIGS. 3 and 4. Here base plate 1 of FIGS. 1 and 2 is replaced by the frame 13 of the suitcase.

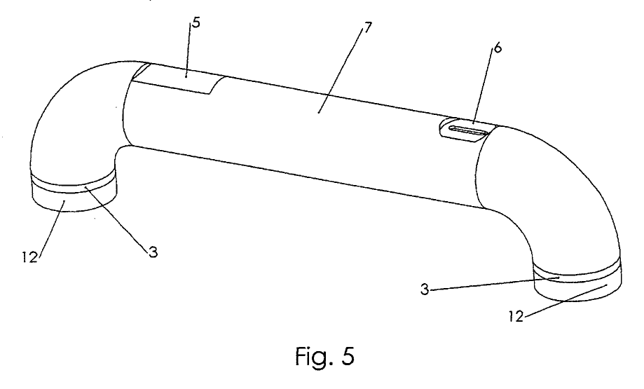

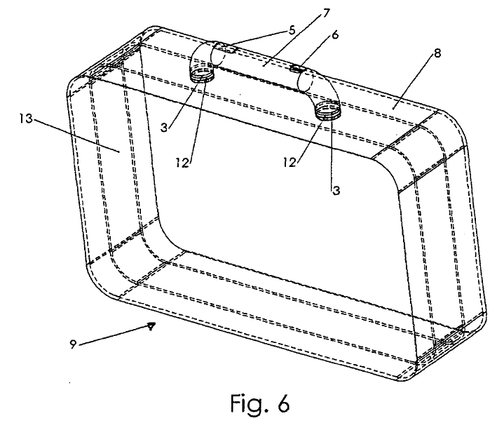

A third embodiment of the present invention incorporates all of the electronics and sensors into the luggage handle as shown in FIG. 5 for ease of retrofit to a piece of luggage. The display 5 is embedded and offset towards one end of the handle for ease of viewing. The battery compartment 6 is located in a convenient location but not necessarily as shown. The load measuring sensors 3 are mounted inline with the downwardly disposed ends of handle 7 so as to be sandwiched between handle 7 and handle mounts 12 so that sensors can measure the full load W of the suitcase when handle 7 is lifted. Thus as seen in FIG. 6, the third embodiment of the present invention is shown with its integrated handle attached to suitcase 9 by the mounting of handle mounts 12 to suitcase frame 13.

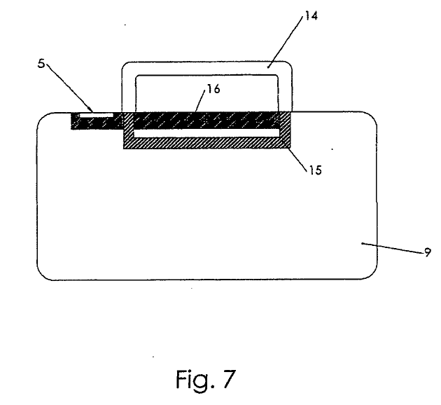

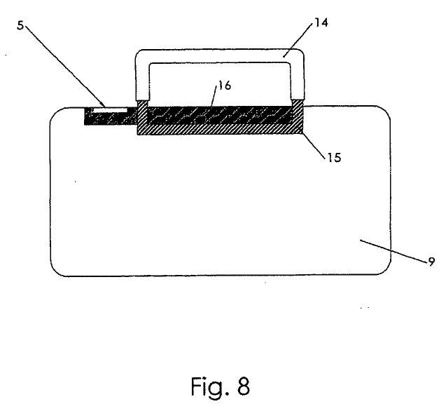

In a fourth embodiment, handle 14 is retractable. Handle 14 slides up and down for example by the upwardly extending ends of carrier 15 telescopically sliding within the corresponding downwardly disposed ends of handle 14. Alternatively, as seen in FIGS. 7 and 8, handle 14 and carrier 15 form a single unitary rectangular piece and the upwardly extending ends of carrier 15 are free to slide up and down in corresponding apertures in the suitcase frame, or base plate 1 or the like. In either case, lifting of handle 14 eventually causes carrier 15 to compress the load sensors 16 as shown in FIG. 8. The load sensors and electronics 16 convert the sensor signal to be displayed on the weight display 5. When the suitcase is lifted by the handle 14, the carrier part of the handle 15 engages and compresses the load sensors and electronics 16 with the weight of the luggage. The sensor signals are converted and displayed on display 5 while the luggage is supported by the handle and for some period after the luggage handle 14 has been released permitting the user to read the weight from the display 5. After some period of time the display will blank and the luggage electronics will go into a battery conserving sleep mode until the handle is lifted again.

In the embodiment of FIGS. 9-17 strain gauges 18, which may be conventional strain gauges or for example may also be piezo film sheet such as PiezoFilm™, are mounted flush on the exposed upper surfaces of flexible metal plates 20. The outermost ends 20a of plates 20 are rigidly mounted to the uppermost ends 22a of rigid mounting legs 22. The opposite lower ends 22b of legs 22 form part of, or mount to, frame 13 of suitcase 9. The opposite, innermost ends 20b of plates 20 are rigidly mounted to the opposite ends of a rigid beam or bar or otherwise a rigid member 24. Plates 20 may be rigidly mounted to legs 22 and rigid member 24 by, for example, threaded nuts 26 threadably mounted onto bolts 28.

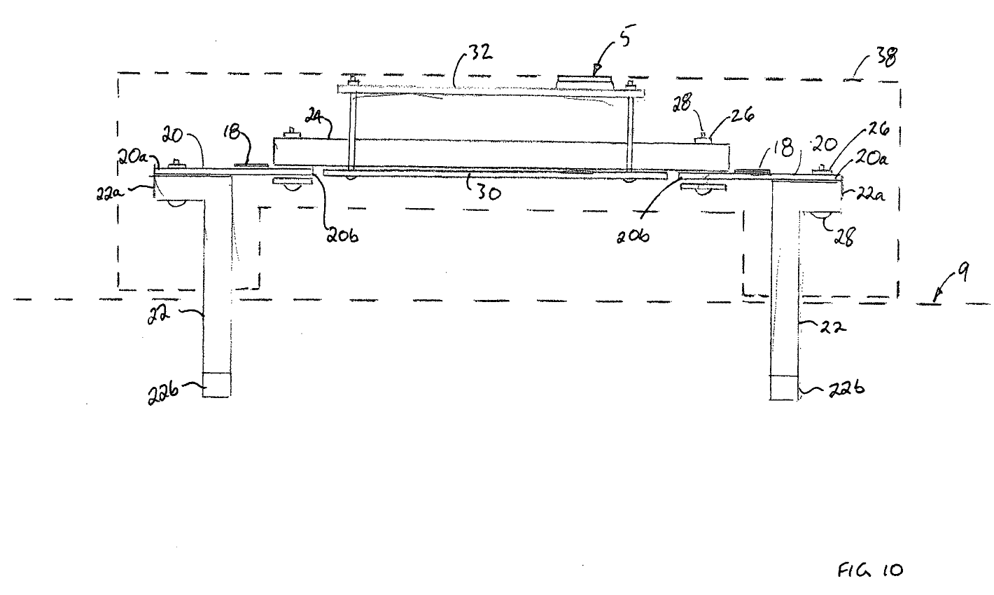

A base plate 30 is rigidly mounted to the underside of rigid member 24. Circuit board 32 (shown in FIGS. 10-17 simplified for clarity), which is understood to contain or support load sensor and scale electronics 16 is mounted to base plate 30. Circuit board 12 is suspended over rigid member 24 by for example nuts 34 threadably mounted on bolts 36 affixed to base plate 30. Display 5 is mounted onto circuit board 32. A hollow housing 38 (shown in dotted outline in FIG. 10) encases legs 22, plates 20, member 24, plate 30 and circuit board 32. Display 5 is visible externally through an aperture in housing 38.

With ends 22b of legs 22 rigidly secured to the suitcase, a user lifting the suitcase by handle housing 38 pulls upwardly on base plate 30. The load of the suitcase is transferred from base plate 30 through rigid member 24 so as to act on flexible plates 20. Plates 20 slightly deform, being rigidly affixed at their ends to the opposite ends of member 24 and the upper ends of legs 22. The deformation is registered by strain gauges 18 and the corresponding elastic deformation or strain data is transmitted to the electronics 16 for processing. The resulting corresponding weight figure is displayed on display 5.

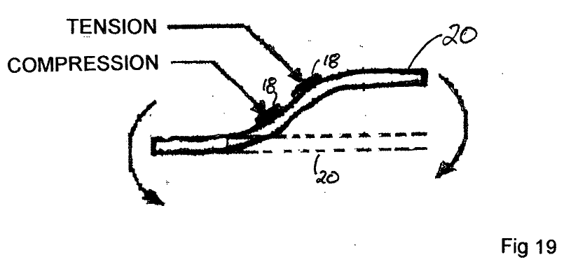

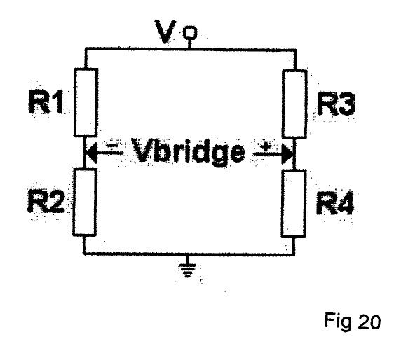

In one embodiment, and as seen in FIG. 19, two load cells are mounted to each plate 20 to generate a voltage signal. The load is subjected to two strains during deformation of plate 20, both tensile and compressive, thereby generating a large signal. Multiple strain gauges are used on the same surface in order to measure both compression and tension on that same surface. Full Wheatstone bridge strain gauges as seen in FIG. 20 are used which are specifically designed for these types of beam loading applications. The signals from the two cells are then amplified by two operational amplifiers so that the output voltage range is from Vss to Vcc. The signals are then digitized by microcontroller and converted into two eight bit numbers, which represent the 256 increments that the scale has. Assuming that the microcontroller is calibrated and the load cells are strained, the signals are compounded and synthesized to produce a single value in pounds. This value is then converted into a four bit binary signal that is sent to two latches. The latches are wired to a three digit LCD and the value in pounds is displayed. At no load the luggage scale goes into a standby mode, in which the display, all of the electrical components and even most of the microcontroller's functions are turned off.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A luggage scale comprising:
a handle mountable to a carrying case,
said handle having a cross member and two down legs extending downwardly at opposite ends of the cross member,
at least said cross member cooperating with at least one deformable member so that, when said handle is mounted to the carrying case, lifting of the carrying case by said handle deforms said at least one deformable member so as to elastically deform said at least one deformable member by a quantifiable deformation quantum related by a mathematical relationship to the weight of the carrying case,
a sensor which comprises a sensing element and said at least one deformable member wherein said sensing element is mounted on said at least one deformable member for sensing said deformation quantum, a processor cooperating with said sensor, said sensor relaying quantum data corresponding to said deformation quantum to said processor,
said processor for determining said weight of the carrying case according to said mathematical relationship,
a display cooperating with said processor for displaying said weight of the carrying case as determined by said processor.

2. The luggage scale of claim 1 wherein said cross member is rigid and wherein said deformable member is at least one flexible member mounted between said cross member and corresponding said down legs.

3. The luggage scale of claim 2 wherein said opposite ends of said cross member are first and second ends, and wherein said at least one flexible member includes first and second flexible members, wherein said first flexible member is mounted to, so as to extend between, said first end of said cross member and a corresponding first down leg of said down legs, and wherein said second flexible member is mounted to, so as to extend between, said second end of said cross member and a corresponding second down leg of said down legs.

4. The luggage scale of claim 3 wherein said flexible members are flexible plates.

5. The luggage scale of claim 4 wherein said down legs are mountable to a frame of said carrying case.

6. The luggage scale of claim 1 wherein said sensing element includes a strain gauge.

7. The luggage scale of claim 6 wherein said strain gauge includes piezo film sheet.

8. The luggage scale of claim 3 wherein said cross member is elongate and wherein said first and second flexible members are also elongate, and oppositely disposed so as to extend from said ends of, and substantially parallel to, said cross member.

9. The luggage scale of claim 8 wherein said processor is mounted to said cross member.

10. A carrying case having a luggage scale handle, said case comprising:
said carrying case having a frame and said handle mounted to said frame,
said handle having a cross member and two down legs extending downwardly at opposite ends of the cross member,
at least said cross member cooperating with at least one deformable member so that, lifting of said frame of said carrying case by said handle deforms said at least one deformable member so as to elastically deform said at least one deformable member by a quantifiable deformation quantum related by a mathematical relationship to the weight of the carrying case,
a sensor which comprises a sensing element and said at least one deformable member wherein said sensing element is mounted on said at least one deformable member for sensing said deformation quantum, a processor cooperating with said sensor, said sensor relaying quantum data corresponding to said deformation quantum to said processor,
said processor for determining said weight of the carrying case according to said mathematical relationship,
a display cooperating with said processor for displaying said weight of the carrying case as determined by said processor.

11. The carrying case of claim 10 wherein said cross member is rigid and wherein said deformable member is at least one flexible member mounted between said cross member and corresponding said down legs.

12. The carrying case of claim 11 wherein said opposite ends of said cross member are first and second ends, and wherein said at least one flexible member includes first and second flexible members, wherein said first flexible member is mounted to, so as to extend between, said first end of said cross member and a corresponding first down leg of said down legs, and wherein said second flexible member is mounted to, so as to extend between, said second end of said cross member and a corresponding second down leg of said down legs.

13. The carrying case of claim 12 wherein said flexible members are flexible plates.

14. The carrying case of claim 13 wherein said down legs are mountable to a frame of said carrying case.

15. The carrying case of claim 10 wherein said sensor element includes a strain gauge.

16. The carrying case of claim 15 wherein said strain gauge includes piezo film sheet.

17. The carrying case of claim 12 wherein said cross member is elongate and wherein said first and second flexible members are also elongate, and oppositely disposed so as to extend from said ends of, and substantially parallel to, said cross member.

18. The carrying case of claim 17 wherein said processor is mounted to said cross member.

19. The carrying case of claim 18 wherein said display is mounted to said cross member.
